(19) United States
(12) Patent Application Publication
(10) Pub. No.: US 2020/0022363 A1
(43) Pub. Date: Jan. 23, 2020

(54) COMPOSITION AND PROCESS DELIVERING A CONTROLLED-RELEASE AGENT

(71) Applicant: Nevada Naturals Inc., Albuquerque, NM (US)

(72) Inventors: Anthony E. Winston, East Brunswick, NJ (US); Richard F. Stockel, Bridgewater, NJ (US); Anthony J. Sawyer, Albuquerque, NM (US)

(21) Appl. No.: 16/335,597

(22) PCT Filed: Sep. 21, 2017
(86) PCT No.: PCT/US17/52611

§ 371 Date: Mar. 21, 2019

Related U.S. Application Data
(60) Provisional application No. 62/455,868, filed on Feb. 7, 2017.
(60) Provisional application No. 62/397,615, filed on Sep. 21, 2016.

(51) Int. Cl. A01N 25/02; A01N 33/12; A01N 47/44; A01N 43/40; A23L 3/3517; A23L 3/3535

(52) U.S. Cl. CPC A01N 25/02; A01N 33/12; A01N 47/44; A23V 2002/00; A23L 3/3517; A23L 3/3535; A01N 43/40

(57) ABSTRACT

Process for forming controlled release antimicrobial salts that include a four-part mixture of (i) an antimicrobial cation, (ii) the anion of an organic acid, (iii) an ammonium, sodium or potassium cation and (iv) an anion such as a halide, acetate or gluconate, dissolved in a solvent so that a concentrate with dissociated controlled release antimicrobial ions is formed. Upon addition of water, controlled-release antimicrobial salt having a solubility in water at 20° C. of greater than about 0.001 (w/w) %, but less than about 1 (w/w) % are formed. Alternatively, a controlled release antimicrobial salt is formed in situ at a site of application containing moisture by addition of a concentrate having dissociated controlled release antimicrobial ions.

### PRIORITY

This application claims benefit to U.S. Provisional Application No. 62/397,615 filed 21 Sep. 2016 and U.S. Provisional Application No. 62/455,868 filed 7 Feb. 2017.

### TECHNICAL FIELD

The technical field relates in general to controlled release salt formulations, and more specifically to salts comprising an antimicrobial cation.

### BACKGROUND

Controlled release ingredients and their uses in personal care, household care and other types of formulations have previously been described in the patent literature. One such group of ingredients are the fatty acid salts of alkyl (C1 to C4) ester of N-α-(C8-C18) alkanoyl dibasic amino acid cation and also quaternary ammonium surfactants, which have anti-microbial, preservative and bacterial-growth inhibitory properties or other benefits as described, for example, in U.S. Pat. No. 9,271,495 “Controlled Release Biocidal Salts; U.S. Pat. No. 8,834,857 and PCT/US2014/051293 and No. WO 2016/024999 A1 “Deodorizing and Skin Cleaning”; U.S. Pat. No. 8,926,997; “Polymeric Biocidal Compositions”; U.S. Pat. No. 8,795,638; Compositions for Dental Care”; U.S. Pat. No. 8,734,879 “Methods for Preservation”; U.S. Pat. No. 9,023,891 B2 and No. WO 2013/169231 A1 “Synergistic Antimicrobial Agents”; and U.S. Pat. No. 8,193,244 Antimicrobial Agents”. These patents and patent applications are incorporated into the teachings of this invention in their entirety.

The selection of the specific salt to be used for a formulation is generally based on its solubility, which is a determining factor in the rate of release of the salt's ions. However, as is often desirable for personal care formulations to provide ingredients in which maximum effectiveness is achieved rapidly due to the almost instantaneous release of the formulation components. However, the downside of rapid release is the possibility that the ingredients will become depleted within a short period of time. On the other hand, the incorporation of controlled release agents allows for longer lasting performance. The above art describes the use of controlled release salts which deliver the desired agents based on the limited solubility of the salts. Therefore, an important criterion for the selection of the specific controlled release salt to be used in a formulation is the salt's solubility, which determines how much of the salt's ions will be immediately available in solution.

Essentially, a sparingly soluble salt comprising two ions, can partially dissolve in the presence of moisture, releasing an effective but useful quantity of its ions. The remaining un-dissolved salt is then available for future dissolution to maintain an effective concentration of dissolved ions as they are used up, or if the solution is otherwise diluted by the entry of additional moisture. Moisture for the release of active ions can be provided by the formulation, can already be present on the treated surface or it can be extracted from humidity in the atmosphere. The latter method can be enhanced, be a formulation that contains, for example, hygroscopic polymers or salts.

As noted in the previously listed patents the controlled release salts can comprise various kinds of ions with a broad assortment of possible uses or benefits. This allows compositions, utilizing the controlled release salts, to be useful for a range of personal care, health care and household applications, and for treating various types of inanimate and animate surfaces for various desired purposes. For example, as described in the above mentioned prior art, skin cleaning and deodorizing formulations can deliver a wide range of cosmetic and therapeutic benefits to the skin and hair. The functional ions comprising these salts may be the anions or cations or both. Compositions containing controlled release salts can be provided in a broad variety of forms, such as liquids, creams, solutions, solid sticks, roll-ons, suspensions, aerosols and pump sprays or powders.

One potential use is to provide controlled release antimicrobial agents for extended activity. However, this is by no means the only benefit which can be provided by controlled release salts. For example, controlled release can reduce irritation by limiting the concentration of the agents to which the skin is exposed. For example, when used alone, exfoliants consisting of highly soluble alpha-hydroxy-acids can be quite irritating to the skin. Using controlled release salts and buffers to deliver small amounts of exfoliating acids over an extended period of time can reduce irritancy by reducing potentially irritating concentrations of the exfoliating acid delivered at one time, while successfully exfoliating skin due to extended of exposure.

The production of high purity controlled release salts comprising an organic cation and the anion of an organic acid can be fairly challenging. For example, as described in U.S. Pat. Nos. 8,212,061, and 9,284,265 B1, organic salts can be produced by melting the hydrochloride salt of the organic cation at 65-70° C., while stirring with a slight (molar) excess of the sodium salt of the organic acid. The temperature rises to about 85° C., due to the reaction between the hydrochloride portion of the cationic active salt and the sodium salt of the organic acid. The reaction is allowed to proceed for between about 30 minutes and 6 hours depending on the salt being formed. Subsequently, while mixing, ethyl acetate or other suitable solvent is added to the reaction vessel, using a ratio of about 5 parts solvent to one part product and the liquid mixture is stirred at 75° C. for a further period, usually of about 30 minutes. During this period, the target salt dissolves in the solvent, leaving un-dissolved sodium chloride as a by-product. While hot, the sodium chloride precipitate is removed by filtration, together with any other insoluble byproducts. The ethyl acetate is then extracted from the mixture by evaporation at 70-75° C. under 50-60 mm Hg of vacuum. However, there is potentially an issue with residual ethyl acetate odor that could be a problem using the above process.

There are several difficulties with the above process. High temperatures during the reaction, solvent extraction and drying phases can lead to the formation of potentially inactive or interfering by-products during the production process. Evaporation of solvents, such as ethyl acetate, is highly energy intensive and costly and requires equipment to recycle the solvent. Also, residual solvent, such as ethyl acetate in the product, can leave an undesirable solvent odor. One purpose of this instant invention is to simplify the above hot system. In the instant invention there is no potential odor caused by residual solvent, filtration is not required, and a costly evaporation step is not needed.

A unique aspect of the instant invention herein described is that anhydrous compositions of the invention deliver the target controlled release salts but do not necessarily contain the controlled release salts until, either (1) water is added to the composition such as when sufficient water is included as an optional ingredient, (2) the composition is added to an aqueous final formulation or (3) the anhydrous composition contacts water during use, for example the anhydrous composition is applied to the skin and the user sweats. In each of these three cases, a controlled release salt will be formed when the ionic concentration of the controlled release salt exceeds its solubility constant in the solvent/water.

In addition to skin cleaning, deodorization and other personal care benefits, the controlled release salts of the compositions of this instant invention can comprise various kinds of ions to broaden the range of benefits provided. For example, as noted above controlled release salts can release controlled quantities of the ions which in equilibrium was water release exfoliating acids over an extended period of time. Also it is possible to use the instant invention by making multiple separate salts in the same formulation, e.g. a water soluble cationic biocide and a combination of two more insoluble sodium organic salts like sodium laurate and sodium salicylate. Compositions of this instant invention are also useful as the basis for various non-personal Care applications, such as for treating all types of inanimate and animal surfaces as well as in the preservation of foods.

### SUMMARY

Accordingly, one or more embodiments provide, in their simplest form, compositions of the instant invention comprise a four-part mixture of (i) an antimicrobial cation, (ii) the anion of an organic acid, (iii) an ammonium, sodium or potassium cation and (iv) an anion such as a halide, acetate or gluconate, dissolved in a suitable solvent. Suitable solvents for the mixture are defined in the instant invention as those solvents in which the combined four-part composition, i.e. the antimicrobial cation, the organic acid anion, the alkali metal cation and the anion, is sufficiently soluble to prevent the ionic mixture from precipitating out from the solution as an un-dissolved salt. Preferred solvents include but are not limited to those selected from the group consisting of 1,2 propylene glycol, glycerin, 1,3 propanediol, butylene diol, pentylene glycol, hexylene glycol, and octanediol. The exact choice of solvent will depend on the amounts and combined solubility of the four ions selected for the composition.

When a composition of the instant invention is diluted with water and the solubility constant of the salt is exceeded, the organic cation will form a salt with the organic anion, producing a precipitate of the target controlled release salt of limited aqueous solubility. With the appropriate selection of cation and anion, the salt precipitate can be caused to adhere to applied surfaces to ensure it remains in the area where it is needed. As noted, the four-part mixture of ingredients is supplied in any suitable solvent such as a glycol or glycerin. To enhance dispersion of the salt in aqueous media, an emulsifier can be included in the composition or can be can be added separately, for example by adding it to the aqueous solution into which the composition is diluted.

An object of the instant invention is to simplify delivery of the target salts in a convenient concentrate form for distribution, dilution, or mixing with other ingredients in final formulations.

A second object is to overcome the manufacturing difficulties and to reduce manufacturing costs associated with producing the target salts and their solutions and to directly produce an essentially pure odorless product already dissolved in a desirable carrier solvent.

A third object of the instant invention is to reduce impurity formation in the product and to assure a more consistent finished product.

A fourth object of this instant invention is to provide compositions containing the target salts which allow greater flexibility in the manufacture of concentrate formulations for compositions with different usage properties.

A fifth object of the instant invention is to deliver effective compositions for the preparation of aqueous and non-aqueous formulations for delivering controlled release salts with various benefits such as deodorization, skin softening, exfoliation, cleaning, sanitization, preservation and other benefits to surfaces and foods.

A sixth object of the instant invention is to increase product yield.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DETAILED DESCRIPTION

In overview, the present disclosure concerns formation and compositions comprising a four-part mixture including an antimicrobial cation. More particularly, various inventive concepts and principles are embodiments in systems, devices, and methods therein for formation of salt formulations.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

As further discussed herein below, various inventive principles and combinations thereof are advantageously employed to prepare salts easily and economically.

Compositions of the instant invention include a controlled release antimicrobial salt composition prepared by a process comprising: dissolving, heating and mixing until uniform: (1) adding from about 0.02 (w/w) % to about 20 (w/w) % of a four-part mixture comprising: (i) one or more antimicrobial cations; (ii) one or more anions of an organic acid; (iii) an ammonium or alkali metal cation; and (iv) an anion, wherein each of (i) and (ii) are in a molar-ratio of to each other between approximately 1:1 and 6:1; (2) to from about 0.2 (w/w) % to about 99.9 (w/w) % suitable solvent for dissolving and dispersing the four-part mixture, so that a composition concentrate is formed that comprises dissociated controlled release antimicrobial ions; and (3) adding the composition concentrate to from about 0.1 wt % to about 99.5% wt % water or deionized water, wherein a controlled release antimicrobial salt composition is formed by the addition of water to the composition concentrate, the controlled-release antimicrobial salt having a solubility in water at 200° C. of greater than about 0.001 (w/w) %, but less than about 1 (w/w) %.

The controlled release antimicrobial salt composition above further comprises one or more of: optionally, from about 0.05 (w/w) % to about 10 (w/w) % emulsifier; and optionally, from about 0.1 (w/w) % to 99.9 (w/w) % of a second suitable solvent distinct from solvent “A” above, for dissolving and dispersing the four-part mixture; optionally, (6) from about 0.05 (w/w) % to about 0.5 (w/w) % fragrance, scent, or flavor oil; and optionally, (7) from about 0.005 (w/w) % to about 0.2 (w/w) % of a dye or colorant.

The controlled release antimicrobial salt formed from the (i) the antimicrobial cations and (ii) organic acid anions listed above has a solubility in water at 20° C. of greater than about 0.003 (w/w) %, but less than about 0.5 (w/w) %.

Preferred cationic antimicrobials are an alkyl (C1 to C4) ester of N-α-(C8-C18) alkanoyl dibasic amino acid cation, cetylpyridinium cation, benzethonium cation, a (C8-C18) alkyl dimethyl benzyl ammonium (benzalkonium) cation, a dialkyl (C8-C18) methyl benzyl ammonium cation, a dialkyl (C8-C18) dimethyl ammonium cation, a polyhexamethylene biguanide cation, and a chlorhexidinium cation.

Also it is possible to use the instant invention by making multiple separate salts in the same formulation, e.g. a water soluble cationic biocide or antimicrobial and multiple more insoluble sodium organic salts like sodium laurate and sodium salicylate.

The end user is defined in the instant application as not a consumer, e.g. not a person in the general population or not an entity, e.g. Walmart, but as a formulator that would take the concentrate and either add it to other ingredients to then make a formulated product to sell to the consumer or entity or would sell the concentrate as a finished product to the consumer or entity, etc. The end user or entity would not utilize final formulation but sell it to the consumer.

Typically concentrated compositions of the invention comprise (1) from about 0.02 (w/w) % to about 20 (w/w) % of the mixture, the four-part mixture being dissolved or dispersed in (2) from about 0.2 (w/w) % to about 99.9 (w/w) % of a suitable solvent in which the combined concentrate mixture is soluble so that a composition concentrate is formed that comprises dissociated controlled release antimicrobial ions with (3) optionally from about 0.1 (w/w) % to about 10 (w/w) % of an emulsifier and (4) optionally from about 0.1 (w/w) % to about 45.0 (w/w) % water. This typical concentrate might be sold by the end user to the consumer or might be part of a fully formulated product. If there is a small amount of the controlled release present in the concentration, then based on the solubility of the controlled release salt made, there will be some small amount of precipitated un-dissociated salt present. The exact levels will be dependent on the end user or intended consumer application, e.g. in a spray deodorant,

In order to make a fully formulated anhydrous composition, for example, made by the end-user/consumer, the instant invention discloses a method of forming a controlled release antimicrobial salt in situ at a site that has moisture present, comprising:

(A) adding (1) from about 0.02 (w/w) % to about 20 (w/w) % of a four-part mixture comprising:
(i) one or more antimicrobial cations;
(ii) one or more anions of an organic acid;
(iii) an ammonium or alkali metal cation; and
(iv) an anion, wherein each of (i) and (ii) are in a molar-ratio of to each other between approximately 1:1 and 6:1; to (2) from about 0.2 (w/w) % to about 99.9 (w/w) % suitable solvent for dissolving and dispersing the four-part mixture, so that a composition concentrate is formed that comprises dissociated controlled release antimicrobial ions;
(B) adding to the composition concentrate, optionally, one or more of:
optionally, (4) from about 0.05 (w/w) % to about 10 (w/w) % emulsifier; and
optionally, (5) from about 0.1 (w/w) % to 99.9 (w/w) % of a second solvent distinct from solvent (2);
optionally, (6) from about 0.05 (w/w) % to about 0.5 (w/w) % fragrance, scent, or flavor oil; and
optionally, (7) from about 0.005 (w/w) % to about 0.2 (w/w) % of a colorant or dye
(3) adding the composition concentrate to from about 0.1 wt % to about 99.5% wt % of an anhydrous solvent to form a diluted composition, and
(4) applying the diluted composition to a site that has moisture present, wherein, the moisture of the site causes the dissociated controlled release antimicrobial ions to form a controlled release antimicrobial salt at the site of application.
Other suitable ingredients needed to complete the desired formulation can be included.

The antimicrobial cations chosen for use as part of the mixture of the composition of the instant invention are desirably safe, biodegradable, cationic agents which are normally conveniently delivered as water-soluble salts, for example as chloride, acetate or gluconate salts. By water soluble, we mean salts with a solubility in water at 20° C. of greater than about 1 (w/w) % at 20° C. Suitable antimicrobial cations for use in compositions of this instant invention include cationic agents with antimicrobial properties. Preferably they are selected from the group comprising N^{α}-lauroyl-L-arginine ethyl ester cation (referred in the instant invention as “LAE”), cetylpyridinium cation, an (C₈-C₁₈) alkyl dimethyl benzyl ammonium (benzalkonium) cation, a benzethonium cation, a (C₈-C₁₈) dialkyl methyl benzyl ammonium cation, a (C₈-C₁₈) dialkyl dimethyl ammonium cation, a polyhexamethylene biguanide cation, and chlorhexidinium cation.

Antimicrobial compositions are especially those useful when applied topically, particularly to mucosal tissues (i.e., mucous membranes), including a cationic antiseptic such as biguanides and bisbiguanides such as chlorhexidine and its various salts including but not limited to the digluconate, diacetate, dimethosulfate, and dilactate salts; polymeric quaternary ammonium compounds such as polyhexamethylenebiguanide; silver and various silver complexes e.g., acetate, citrate that form low soluble salts; small molecule quaternary ammonium compounds such as benzalkonium chloride and alkyl substituted derivatives; di-long chain alkyl (C8-C18) quaternary ammonium compounds; cetylpyridinium halides and their derivatives; benzethonium chloride and its alkyl substituted derivatives; and octenidine. The compositions can also include an enhancer component, a surfactant, a hydrophobic component, and/or a hydrophilic component. Such compositions provide effective topical antimicrobial activity and are accordingly useful in the treatment and/or prevention of conditions that are caused, or aggravated by, microorganisms (including viruses).

Cationic biocides (CBs) have been in use since the 1930s for surface disinfection and topical antisepsis. Broad-spectrum activity and relatively low toxicity have led to increased deployment of these compounds in medicated dressings, in contact lens cleaning solutions, in swimming pools to control microbial growth, and in domestic cleaning products. While CBs are a chemically diverse group of compounds, their mode of action normally involves interaction with the cell envelope, displacing divalent cations. Subsequent interactions with membrane proteins and the lipid bilayer depend upon the specific nature of the biocide, but generally CB exposure results in membrane disruption and lethal leakage of cytoplasmic materials. CBs have a range of structures that can be categorized according to the number of cationic groupings per molecule. The quaternary ammonium compounds ([QACs] e.g., cetrimide) are often monocationic surfactants generally containing one quaternary nitrogen associated with at least one major hydrophobic component. The bisbiguanides (e.g., chlorhexidine [CHX]) have two cationic groups separated by a hydrophobic bridging structure (hexamethylene) while the polymeric biguanides (e.g., polyhexamethylene biguanide [PHMB]) are polycationic linear polymers with a hydrophobic backbone and multiple cationic groupings separated by hexamethylene chains.

Organic acid anions of the composition are those with one to 18 carbon atoms that form a salt with limited solubility in water with one or more of the following target cations: an alkyl (C1 to C4) ester of N-α-(C8-C18) alkanoyl dibasic amino acid cation, a cetylpyridinium cation, an (C₈-C₁₈) alkyl dimethyl benzyl ammonium (a benzalkonium) cation, a benzethonium cation, an (C₈-C₁₈), a (C₈-C₁₈) dialkyl methyl benzyl ammonium cation, a (C₈-C₁₈) dialkyl dimethyl ammonium cation or chlorhexidinium cation. By salts with a limited solubility in water, we mean ones with a solubility in water of less than about 1% (w/w) at 20° C., preferably less than 0.5% (w/w) but with an aqueous solubility of greater than about 0.001% (w/w), preferably greater than about 0.003 (w/w) % at 20° C. As discussed, since it is only the cationic component of the antimicrobial salt which is responsible for this compound's antimicrobial and preservative activity, the choice of the anionic component of the salt is not critical, as long as the solubility of the salt is sufficient to enable it to release a sufficient amount of the antimicrobial cation to control microbial growth when dissolved in water at RT. Examples of suitable anions include but are not limited to lactate, mandelate, glycerophosphate, mono-carboxylates, hydroxyl-mono-carboxylates, dihydrogen phosphate, polyphenolates, and phenolates. Reduced solubility salts, which may be useful in some applications, can be obtained using longer chain fatty acids or hydroxy-carboxylates. For example, preferred examples of reduced solubility salts include the monocarboxylates and monohydroxycarboxylates with from about 8 to about 18 carbon atoms. However certain properties of the anionic component can have beneficial effects that can be exploited for specific end use applications.

Particularly preferred organic acid ions are: acetate, propionate, butyrate, caproate, caprylate, decanoate, undecylenate, laurate, myristate, palmitate, stearate, oleate, linoleate, lactate, salicylate, glycolate, tartrate, malonate, malate, succinate, citrate, gluconate, glycerate glyoxylate, ascorbate and retinoate, sorbate, and dehydroacetate

In some cases, to provide for maximum extended effectiveness, it is desirable to maximize the amount of controlled release salt while minimizing the amount of free cations delivered from the salt. This is accomplished by utilizing close to a 1:1 molar ratio of organic antimicrobial cations to organic counter anions. The amount of free cation delivered and maintained in an aqueous solution from such a composition, will then be limited by the solubility constant of the salt formed from the organic cation and organic anion in the aqueous medium. Because of the limited solubility of these salts and hence the amount of free cations present in aqueous solution, such salts have limited, if any, cidal activity against bacteria but can inhibit bacterial growth and regrowth.

On the other hand, to assure increased activity on initial application of the formulation, it is sometimes desirable for the composition to deliver higher amounts of rapidly acting dissolved organic cations. This is accomplished by increasing the molar ratio of cation to anion and hence reducing the amount of controlled release salt formed. While there is no actual maximum to the ratio of organic antimicrobial cation to organic counter anion that can be present in the composition, a ratio of about 6:1 is a useful practical maximum to assure the delivery of an adequate amount of the controlled release salt and hence provide the assurance of some extended activity. Accordingly, based on the above considerations relating to speed of action and extended activity, a preferred range for the molar ratio of antimicrobial cation to counter anion is between about 1:1 and about 6:1.

Another way of modifying the amount of free antimicrobial released by the salt is to select an organic acid anion for the composition, which results in the formation of an organic cation-anion salt with a lower or higher aqueous solubility depending on the needs of the formulation. For example, by choosing an anion with a higher molecular weight, the aqueous solubility of the salt will generally be decreased, resulting in less free cation being dissolved in its aqueous solution at any one time; conversely by choosing a fatty acid anion with a lower molecular weight, the aqueous solubility of the salt will generally be increased, resulting in more free cation being available in aqueous solution.

The ammonium or alkali metal cation, and the its counter anion selected for the composition are not critical to the performance of the composition. Their presence usually results from the preferred method of producing the solutions of cationic antimicrobial and anionic organic acid ions of the composition as will be subsequently described below.

Concentrates of the instant invention optionally also contain nonionic or amphoteric emulsifiers. This is especially desirable, if water is to be added to the composition or if it is desired to disperse the anhydrous composition into an aqueous solution. Nonionic or amphoteric emulsifiers disperse compositions of the instant invention in water as emulsions or microemulsions. In some cases, where there is a relative large molar ratio of cationic antimicrobial to organic acid anion, the addition of nonionic or amphoteric emulsifiers is not necessary to keep the controlled release salt dispersed in aqueous solution. This is because some antimicrobial cations can emulsify and effectively disperse the controlled release salt in aqueous solution.

Suitable nonionic or amphoteric emulsifiers for the composition have an HLB equal to or greater than about 10. Non-limiting examples of suitable nonionic emulsifiers include ethoxylated alcohols, PEG-40 hydrogenated castor oil, PEG-60 hydrogenated castor oil, polysorbate 20, polysorbate 40. polysorbate 60 and polysorbate 80, an alkyl polyglucoside, and mono and di saccharide esters of a fatty acid with 8 to 18 carbons, including fructose, glucose, galactose, sucrose. lactose, and maltose esters.

Almost any kind of water soluble amphoteric surfactant can be used as an emulsifier in concentrates of this instant invention. Non-limiting examples of suitable types of amphoteric surfactants include alkali metal or ammonium salts of: an alkyl amphoacetate, an alkyl amphodiacetate, an alkyl amphopropionate, an alkyl amphodipropionate, an alkyl betaine, an alkyl amidobetaine, an imadazoline derivative, an alkyl sulfobetaine derivative, an alkyl sultaine derivative, an alkyl hydroxysultaine derivative, an alkyl iminoacetate, and an iminodialkanoate.

Specific non-limiting examples of amphoteric surfactants include sodium lauroamphoacetate, sodium cocoamphoactate, disodium lauroamphodiacetates, disodium cocoamphodiacetate, sodium lauroamphopropionate, sodium cocoamphopropionate, disodium alkyl amphodipropionate, disodium cocoamphodipropionate, laurobetaine, cocobetaine, cocoamidopropyl betaine, and tegobetaine.

Most conveniently concentrates of the instant invention can be prepared which can easily be formulated into finished products by dilution in solvents or water and with the addition of any other ingredients required to meet the specific needs of the finished formulated product.

The instant invention discloses a process for producing a controlled release antimicrobial salt comprising:

(A) dissolving, heating and mixing until uniform:
(1) from about 0.02 (w/w) % to about 20 (w/w) % of (1) a four-part mixture comprising:
(i) one or more antimicrobial cations;
(ii) one or more anions of an organic acid;
(iii) an ammonium or alkali metal cation; and
(iv) an anion, wherein each of (i) and (ii) are in a molar-ratio of to each other between approximately 1:1 and 6:1; and (2) from about 0.2 (w/w) % to about 99.9 (w/w) % of a suitable solvent for dissolving and dispersing the four-part mixture, so that a composition concentrate is formed that comprises dissociated controlled release antimicrobial ions; and
(B) adding the composition concentrate to (3) from about 0.1 wt % to about 99.5% wt % water or deionized water, wherein a controlled release antimicrobial salt composition is formed by the addition of water to the composition concentrate, the controlled-release antimicrobial salt having a solubility in water at 20° C. of greater than about 0.001 (w/w) %, but less than about 1 (w/w) %.

The process above further comprise one or more of: optionally, (4) from about 0.05 (w/w) % to about 10 (w/w) % emulsifier; and optionally, (5) from about 0.1 (w/w) % to 99.9 (w/w) % of a second suitable solvent distinct from solvent (2); optionally, (6) from about 0.05 (w/w) % to about 0.5 (w/w) % fragrance, scent or flavor oil; optionally (7) from about 0.005 (w/w) % to about 0.2 (w/w) % of a colorant or dye; and optionally (8) preservatives, emollients, cleaning agents, are added to the composition.

The process above further comprises mixing until uniform from about 0.1% (w/w) to about 10% (w/w) of the controlled release antimicrobial salt four-part mixture with one of the following: (a) from about 75% (w/w) to about 99.9% (w/w) deionized water; (b) from about 75% (w/w) to about 99.9% (w/w) of additional suitable solvent; or (c) from about 75% (w/w) to about 99.9% (w/w) of a second suitable solvent in which the ingredients of the composition are soluble, wherein, a diluted a controlled release antimicrobial salt composition is formed.

The instant invention also discloses a method of forming a controlled release antimicrobial salt in situ at a site that has moisture present comprising: (A) adding (1) from about 0.02 (w/w) % to about 20 (w/w) % of a four-part mixture comprising: (i) one or more antimicrobial cations; (ii) one or more anions of an organic acid; (iii) an ammonium or alkali metal cation; and (iv) an anion, wherein each of (i) and (ii) are in a molar-ratio of to each other between approximately 1:1 and 6:1: to (2) from about 0.2 (w/w) % to about 99.9 (w/w) % of a suitable solvent for dissolving and dispersing the four-part mixture, so that a composition concentrate is formed that comprises dissociated controlled release antimicrobial ions; (B) adding to the composition concentrate, optionally, one or more of: optionally, (4) from about 0.05 (w/w) % to about 10 (w/w) % emulsifier; and optionally, (5) from about 0.1 (w/w) % to 99.9 (w/w) % of a second solvent distinct from solvent (2); optionally, (6) from about 0.05 (w/w) % to about 0.5 (w/w) % fragrance, scent, or flavor oil; and optionally, (7) from about 0.005 (w/w) % to about 0.2 (w/w) % of a colorant or dye (3) adding the composition concentrate to from about 0.1 wt % to about 99.5% wt % of an anhydrous solvent to form a diluted composition, and (4) applying the diluted composition to a site that has moisture present, wherein, the moisture of the site causes the dissociated controlled release antimicrobial ions to form a controlled release antimicrobial salt at the site of application.

Final formulated concentrate compositions suitable for dilution for preparing commercial products for can be prepared by (1) dissolving from about 0.02 (w/w) % to about 2 (w/w) % of (i) cationic antimicrobial salt selected from the group comprising an alkyl (C1 to C4) ester of N-α-(C8-C18) alkanoyl dibasic amino acid halide, cetylpyridinium chloride, benzethonium chloride, a (C₈-C₁₈) alkyl dimethyl benzyl ammonium (benzalkonium) chloride, a dialkyl (C₈-C₁₈) methyl benzyl ammonium chloride, a dialkyl (C₈-C₁₈) dimethyl ammonium chloride and chlorhexidinium digluconate and (ii) an ammonium or alkali metal salt of an organic acid, said salts being in a molar ratio between about 1:1 and about 6:1 respectively, in (iii) from about 0.2% (w/w) to about 20% (w/w) of solvent in which the salts are soluble, while warming if necessary to hasten dissolution, (2) adding while mixing from about 0.05% (w/w) to about 10% (w/w) of an emulsifier (3) optionally while mixing adding from 0.05% (w/w) to about 0.5% (w/w) fragrance, scent, or flavor oil, and (4) optionally while mixing, adding 0.005% (w/w) to about 0.2% (w/w) of a dye and (5) adding while mixing one or more of the following: (A) from about 75% (w/w) to about 99.9% (w/w) deionized water and mixing until uniform or (B) from about 75% (w/w) to about 99% (w/w) of additional suitable solvent or (C) from about 75% (w/w) to about 99% (w/w) of a second non-aqueous solvent in which the composition is soluble. Additional ingredients such as preservatives, emollients, cleaning agents and the like can be incorporated into the formulation as needed.

Fully formulated formulations can also be prepared by diluting a concentrate composition of the instant invention. Thus 0.1% (w/w) to about 10% (w/w) of a suitable concentrate composition is (1) diluted into either (A) from about 75% (w/w) to about 99.9% (w/w) deionized water, (B) from about 75% (w/w) to about 99% (w/w) of suitable solvent or (C) from about 75% (w/w) to about 99% (w/w) of a second suitable solvent distinct from (B) in which the composition is soluble, (2) optionally while mixing adding from about 0.1% (w/w) to about 5% (w/w) of an emulsifier, (3) optionally adding 0.05% (w/w) to about 0.5% (w/w) of a fragrance, scent, or flavor oil, (4) optionally while mixing, adding from about 0.005% (w/w) to about 0.2% (w/w) of a dye or colorant, and (5) adding any other ingredients needed to complete the formulation and the composition is mixed until uniform.

In making up concentrate and fully formulated formulations, the actual order of addition of the ingredients into the product is not important and does not affect the integrity of the compositions. Furthermore, the salts of the organic acid can be formed in situ from equimolar quantities of the hydroxides of ammonium, sodium or potassium hydroxide and the organic acid. These can be added to the solution at any point during the process. Additionally, the emulsifier can be added to the mixture in undiluted form or it can be added in the form of an aqueous or non-aqueous solution.

A unique aspect of the instant invention herein described is that anhydrous concentrates of the instant invention do not necessarily contain the actual controlled release salts which are delivered from formulations utilizing the concentrate. Indeed, anhydrous concentrates of the invention contain the four-part composition in dissolved dissociated ionic form, resulting in the composition being in the form of a convenient to use uniform liquid. The un-dissociated controlled release salts only form when, either (1) water is added to the composition such as when water is included as an optional ingredient, (2) the composition is mixed in an aqueous final formulation or (3) the anhydrous concentrate contacts water during use, for example, the anhydrous concentrate is applied to skin and the user sweats. In each of these three cases where the concentrate is contacted with sufficient water, the un-dissociated controlled release salt will immediately form if the ionic concentration exceeds the solubility constant of the controlled release salt in the solvent/water combination present.

Compositions of the invention constitute concentrates which are subsequently diluted when the desired formulations are assembled for provision to the ultimate user or for marketing to the final consumer. The concentrates can be anhydrous or aqueous and can serve as a useful means of storing the ingredients of the composition and can easily be diluted into the final formulation. Typically, the concentrated compositions of the invention will contain between about 0.02 (w/w) % to about 20 (w/w) %, and preferable about 5 (w/w) % to about 20 (w/w) %, and most preferably around 10 (w/w),% of the four-part composition dissolved in a suitable solvent. In preparing a final formulation for customer use, the concentrates are usually added to the final formulation at a concentration of from about 0.2 (w/w) % to about 2 (w/w) % of the final formulation. Compositions of the invention are not necessarily concentrates but can be final formulations. Final formulations usually contain lower amounts of the four-part mixture, for example from about 0.1 (w/w) % to about 5 (w/w) % of the solvent.

Final formulations that an end prepares to supply to consumers or that are supplied as concentrates to consumers can also be aqueous or non-aqueous. If sufficient water is present, aqueous formulations will usually contain all or part of the target controlled release salt in un-dissolved form. In order for the salts to be properly dispersed in aqueous media of final formulations an emulsifier is therefore generally needed. The emulsifier can be incorporated into the concentrate composition or added separately by the end user to the final formulation. The emulsifier will serve to disperse the insoluble salt. It is desirable to adjust the level of emulsifier to provide for uniform deposition and spreading on surfaces to which the formulation is applied. Thus a non-aqueous solution according to the invention may contain no water or small amounts of water. Likewise, an aqueous solution may contain amounts, from about 0.001 (w/w) % to about 45 (w/w) % of an anhydrous solvent and yet still be considered an aqueous solution if the predominate solvent is water.

Concentrate compositions of the invention can also be diluted into anhydrous formulations. For example, compositions of the invention will dissolve in alcohol, e.g. ethanol in a deodorant body spray. However, even in alcohol-based formulations, where an emulsifier is not essential to emulsify the composition ingredients in the alcohol, it is advisable to add some amount of emulsifier to assure that it spreads on surfaces and does not form small insoluble clumps of controlled release salt due to precipitation with moisture on treated surfaces.

Preferred concentrate compositions are stable liquids which contain the controlled release salt fully dispersed in dissociated ionic form.

In some cases, it is desirable to maximize the amount of controlled release salt delivered from the composition, for example when speed of action is less critical than extended benefit. This is accomplished by utilizing, no more than about a 1:1 molar ratio of antimicrobial cation to organic acid anion. The amount of free cation, which will then be delivered and maintained in an aqueous solution to which the composition is added will then be limited by the solubility product of the salt formed from the cation and anion in the aqueous medium. In this case, almost all of the antimicrobial or preservative cation will be combine to deliver the controlled release salt. It may be noted that while preferably the ratio of antimicrobial cationic to organic acid anion should desirably be no less than 1:1, a lower ratio could be used without departing from the spirit of the instant invention. However, with a lower ratio of cationic antimicrobial to organic acid anion, the amount of free antimicrobial cation in solution will be suppressed in aqueous solution, due to the “common ion effect” resulting from higher concentrations of free organic acid anions present. Solutions primarily containing controlled release salt but not much free cationic antimicrobial may not be strongly antimicrobial but the effect provided by the released cationic ion will be longer lasting.

If it is preferred for formulations to deliver more biocidal effectiveness, the molar ratio of cationic antimicrobial to organic acid anion, can be increased. Usually the molar ratio of cationic antimicrobial to organic acid anion would be no more than about 6:1 to also ensure that an adequate amount of the controlled release salt is delivered. The overall preferred range for the molar ratio of antimicrobial cation to organic anion is between a ratio of about 1:1 to about 6:1. It may be noted that when a higher than ratio 1:1 ratio of cationic to anionic organic acid is used, additional emulsifiers are often not needed because the free ionic cationic antimicrobial can often be sufficiently hydrophilic to disperse the controlled release salt as an emulsion or micro-emulsion. Obviously, another way of modifying the amount of dissolved antimicrobial is to replace the organic acid with another organic acid to decrease or increase respectively the solubility of the controlled release salt.

Whether there is water in a concentrate will depend on the requirements of the end user. If there is some small amount of water, e.g. about 0.1 wt %, there will be a small amount of undissociated controlled release salt. As disclosed herein, a unique aspect of the instant invention herein described is that anhydrous compositions of the invention deliver the target controlled release salts but do not necessarily contain the controlled release salts until, either (1) water is added to the composition such as when sufficient water is included as an optional ingredient, (2) the composition is added to an aqueous final formulation or (3) the anhydrous composition contacts water during use, for example the anhydrous composition is applied to the skin and the user sweats. In each of these three cases, a controlled release salt will be formed when the ionic concentration of the controlled release salt exceeds its solubility constant in the solvent/water. There are examples in the disclosure where the concentrate contains a limited amount of water. This amount of water is sufficient to allow for the concentrate to have some undissociated salt present while also having also antimicrobial cations when applied further diluted with suitable solvent and/or applied to a surface, to deliver a certain quantity of undissociated controlled release salt to the surface, while also delivering additional controlled release salt while the moisture on the surface reacts with the dissociated ions on the controlled release salt. This assures that an immediate amount of low soluble salt is available to release the cationic antimicrobials over a period of time.

The preferred solubility in water at 20□ is greater than about 0.001 (w/w) %, but less than about 1 (w/w) %.

The preferred amount of water or deionized water to be added to a concentrate of this invention is about 0.1 (w/w) % to about 99.5 (w/w) %.

The levels of various components of the concentrates of the instant invention are based on the requirements of the end user. The concentrates can be custom formulated. The various levels of the four-part mixture are constant due to the molar ratios. However, each level of emulsifier, colorant, dye, or other additives is custom formulated for the end user's various applications. The concentrates can also be sold without any further formulation by the end user to the consumer, which would require various levels of non-four part components of the concentrate.

The preferred level of controlled release antimicrobial salt four-part mixture in the concentrate is about 0.02 (w/w) % to about 20 (w/w) % where there will exist almost all undissociated salt.

However, to make a diluted controlled release salt mixture (no ions remaining) from concentrate, the preferred amount of the controlled release antimicrobial salt four-part mixture is from about 0.1 (w/w) % to about 10 (w/w) % when a non-anhydrous final formulation or concentrate for an end user is desired.

The preferred level of a fragrance, scent, or flavor oil is from about 0.05 (w/w) % to about 0.5 (w/w) %.

The preferred level of dye or colorant is from about 0.005 (w/w) % to about 0.2 (w/w) % of a dye or colorant.

Non-limiting examples of applications for the compositions of this instant invention include antimicrobial products, household products and cleaners, fabric detergents, dish detergents, cleansers, soaps, bubble baths, disinfectants, deodorizers, foods, food products, beverages, preservative compositions, antimicrobial packaging, pharmaceutical products, medical devices, contact lenses, cosmetics, hygiene compositions, infant care products, antimicrobial soaps, hand sanitizers, deodorants, antiperspirants, anti-microbial coatings, oral care compositions, dental compositions, toothpastes, mouthwashes, lipsticks, dental appliances, medications, athlete's foot treatments, medicated chewing gums, dermatological compositions, acne treatments, skin conditioners, skin moisturizers, anti-wrinkle formulations, skin whiteners, sunscreens, tanning lotions, hair products, shampoos, shower gels, bubble baths, conditioners, shaving creams, spermicides etc. Also included are microbial-resistant fabrics and apparel, anti-microbial condoms, surgical gowns, microbial-resistant hospital equipment, anti-microbial paper products, animal care products, antimicrobial plastics, antimicrobial plastic devices, rubbers and other fabrication materials, appliances with antimicrobial constituents or coatings, etc.

With respect to food products, the compositions of this instant invention are particularly useful as food preservatives. They are typically incorporated into the food products being preserved or applied to the food products in the form of aqueous solutions, emulsions or microemulsions such that the composition should be present in an amount of between about 10 ppm and about 20,000 ppm of the food product, more preferably 50 ppm to 5000 ppm of food product. The salt may be applied to the food product by any techniques for example by spraying, immersion, dipping, injection or direct addition to the food product.

Examples of foods which can be preserved with compositions of the instant invention include but are not limited to meats, poultry products, fish, crustaceans, vegetables, greens, emulsions, sauces, confectionery, candies, chewing gum, bakery, dairy products, egg-based products, jams, jellies, beverages, juices, wines and beers etc.

Additionally, compositions of the instant invention can also be added to the food packaging from where it can release preservatives into the food product being preserved. Generally, where added to food packaging, the amounts of composition needed to effect food preservation would be higher than the amount needed when incorporated directly into food. Typically, from about 100 ppm to about 5 (w/w) % by weight of the food packaging food products would be used.

Additionally, plastics and miscellaneous products can be coated and/or impregnated with the compositions of the instant invention, including: medical items, e.g., thermometers, catheters, surgical sutures, blood lines, implants, bandages, surgical dressings, surgical apparel, respirators, etc.; fluid-dispensing tubing; drug and cosmetic packaging; eating utensils; shower curtains; bath mats; sponges; mops; toilet seats, rubber gloves; contact lenses; hearing aids; shelving paper; carpet pads; pool covers; animal bedding and cat litter; computer covers and computer keys; doorknobs; tampons and sanitary napkins; adult novelties; sexual aids; sex toys; pregnancy barriers; dental chairs; dryer sheets; dishcloths; paints and coatings; deodorizing liquids, solids, sprays, gels and powders; filters; foams; hair brushes; combs; diaper rash preventer; plasma bag treatment; disposable glove treatment; additive to pasteurized cow milk; additive to blood sample tubes to inactivate HIV, HCMV, and other viruses (safety measure for lab technicians and healthcare providers); additives for condoms, or bandages; additive for paint; or animal or plant treatment for microbial infections; and the like.

Additionally, fibers and fabrics can be coated and/or impregnated with the compositions of the instant invention, including natural and synthetic fibers and fabrics manufactured from such fibers; wipes, cloths; surgical gauze; crib covers; bassinet covers; bed linens; towels and wash cloths; tents; draw sheets; cubicle curtains; shower curtains; wall coverings; wood and wood products; hospital clothing such as examination robes, physicians' coats, nurses uniforms, etc.; apparel; paper, non-woven fabric, knitted fabric, woven fabric, brick, stone, plastic, polymer, latex, metal, tile, walls, floors, gurneys, tables, or trays; shoes and the like.

Cleaning products can usefully incorporate combinations of the instant invention for the purposes of sanitizing or deodorizing surfaces. Typically, the compositions would be added to aqueous cleaning formulations in concentrations between about 100 ppm to about 2000 ppm. Other cleaning agents can be added at the concentrations needed to make the products effective which will depend on usage concentration. Most cleaning formulations contain surfactants. As mentioned previously, virtually all nonionic, amphoteric and cationic surfactants are generally compatible with the combinations of the instant invention. However, most anionic surfactants will cause antimicrobial cationic salts to precipitate from solution.

### EXPERIMENTAL DATA

In the following tables, there are data from microbiological tests that the inventors use as a screening tool. These tests are referred to as an “Inhibition Test” and a “Survivability Test” that are described as follows:

In the “Inhibition Test”, clear aqueous test solutions containing the active ingredients and optional solubilizers were diluted 1:1 by volume with inoculum broth containing S. aureus bacteria. After incubating for 48 hours at 370, the solutions were examined for evidence of bacterial growth (cloudy) or complete inhibition of growth indicated by a clear solution (No Growth).

In the “Survivability Test”, those solutions which remained clear (i.e. indicated no growth) and a few cloudy solutions (i.e. with growth) from the inhibition test were treated with 9 parts Letheen neutralizing broth to one part test solution and vortexed. One ml of this quenched solution was plated onto a petri dish and incubated for 48 hours at 37° C. The number of colonies were then counted and recorded as a count between 0 and 50 or as TNC (too numerous to count).

Table 1 compares the MIC (minimum inhibitory concentration) and MBC (minimum bactericidal concentration) of four various samples of LAE laurate (“LAEL”) salts using the procedures of this invention. All samples were tested using MIC and MBC tests against Corynebacter xerosis (“c.x.”). Samples 1-2 were in combination with monolaurin (“ML”). Tego Betaine F-50 acts as an emulsifier and is preservative free. “DW” is deionized water. Sources of LAEL as listed in Table 1 as “in situ in pentylene glycol” were made using the process described in instant invention disclosure.

TABLE 1

| | | | | | Tego | | | |
|---|---|---|---|---|---|---|---|---|
| | | | | | Betaine | DW | MIC | MBC |
| Method/Sample | | Source of | | Pentylene | F-50 | to | c.x., | c.x., |
| #, composition | LAEL, g | LAEL | Monolaurin, g | glycol, g | (real), g | 100 g | ppm | ppm |
| Inventive/1 | 0.375 | In-situ in | 0.125 | 7 | 2 | qs | 4-8 | 4-8 |
| | | pentylene | | | | | | |
| | | glycol | | | | | | |
| Prior Art/2 | 0.375 | V&V | 0.125 | 7 | 2 | qs | 8-16 | 8-16 |
| | | Pharma | | | | | | |
| | | lot 2015 | | | | | | |
| Inventive/3 | 0.375 | In-situ in | 0 | 7 | 2 | qs | 32-61 | 250 |
| | | pentylene | | | | | | |
| | | glycol | | | | | | |

In Table 1, samples 1 and 3 were made using the in situ solvent method disclosed in the instant invention utilizing pentylene glycol as the solvent. Sample 2 was made using LAE laurate from V&V Pharma, Mumbai, India. The data in Table 1 shows that LAE laurate (“LAE-L” or “LAEL”) made using the solvent in situ instant invention process produces equivalent cidal activity to the LAEL made by the supplier (V&V Pharma, Mumbai, India) using the ethyl acetate system as described in U.S. Pat. No. 9,284,265 B1. The “Inhibition Test” only uses one dilution condition, i.e. 1:1 inoculum to test solution ratio for initial screening. The second step is to measure the bacterial survivability in those “Inhibition Test” solution samples where growth inhibition was apparent. In some testing we included samples which were cloudy to avoid missing inhibitory formulations which were cloudy for reasons other than bacterial growth. The survivability part of the test is semi-quantitative giving a reasonably good indication of effectiveness based on the number of colonies which regrow after quenching the active antimicrobial.

In Table 2 a 10 wt % solution of benzalkonium laurate and monolaurin (3:1 ratio) in propylene glycol was prepared with the following ingredients and procedure.

TABLE 2

| Raw Materials | Wt % |
|---|---|
| Benzalkonium chloride | 8.80 |
| (50% aqueous solution) | |
| Lauric acid | 3.10 |
| Sodium hydroxide | 0.62 |
| Monolaurin | 2.50 |
| Propylene glycol | 84.98 |
| Total | 100.00 |

As described in Table 2, while stirring 3.1 wt % lauric acid was added to 84.98 wt % propylene glycol. After dissolution of the lauric acid 0.62 wt % sodium hydroxide pellets were added to the solution, while mixing and warming, to accelerate the dissolution of the sodium hydroxide. After the sodium hydroxide had dissolved, 8.8 wt % benzalkonium chloride was added while stirring, followed by 2.5 wt % monolaurin. A small amount of heating, typically up to 50□, was required to speed the ingredients into solution. The resulting solution containing a Benzalkonium Laurate/Monolaurin Concentrate was clear and had the following composition in Table 3:

TABLE 3

| Ingredients | |
|---|---|
| Benzalkonium laurate | 7.50 wt % |
| Monolaurin | 2.50 |
| Sodium chloride | 0.91 |
| Water | 4.11 |
| Propylene glycol | 84.98 |
| Total | 100.00 |

The benzalkonium laurate/monolaurin concentrate in Table 3 was used to produce the following two aqueous test formulations listed in Table 4:

TABLE 4

Sample #

| Ingredients | TF-1 | TF-2 |
|---|---|---|
| Benzalkonium laurate/ | 0.50 wt % | 0.50 wt % |
| monolaurin concentrate | | |
| Polysorbate 20 | 0.30 | 5.00 |
| Deionized water | 99.20 | 94.45 |

The formulations in Table 5 were tested for their ability to inhibit S. aureus growth and for their bacterial survivability using the Inhibition and Survivability test methodology described in the instant invention disclosure. In Table 5, after 1:1 dilution in the inoculum of the solutions listed in Table 4, the solutions in Table 5 had the following concentrations of benzalkonium laurate/Monolaurin and Polysorbate (TNC=too numerous to count.):

TABLE 5

Sample #

| Ingredients | TF-1 | TF-2 |
|---|---|---|
| Benzalkonium laurate/ | 0.025 wt % | 0.025 wt % |
| Monolaurin | | |
| Polysorbate 20 | 0.15 | 2.5 |
| Inhibition of growth | Yes | Yes |
| Surviving Bacterial count | 0 | TNC |

The results in Table 5 show that both formulations inhibit the growth of the S. aureus bacteria. However, when a relatively high concentration (2.5 wt %) of polysorbate 20 emulsifier (2.5 wt %) is present the treated bacteria can survive. However, when only a small amount (0.15 wt %) of the emulsifier is present survivability is reduced by at least 4 to 5 logs.

It has been found, as will be illustrated in the examples, that the addition of lower HLB emulsifiers can enhance the ability of compositions of the invention to inhibit bacterial growth and to reduce survivability of the bacteria. Three additional formulations containing the same benzalkonium laurate/monolaurin (3:1) concentrate prepared for their ability to inhibit bacterial growth and reduce bacterial survivability as listed in Table 6 as follows:

TABLE 6

| | Sample # | | |
|---|---|---|---|
| Ingredients | TF-3 | TF-4 | TF-5 |
| Benzalkonium laurate/ | 0.50 wt % | 0.50 wt % | 0.50 wt % |
| monolaurin (3:1) concentrate | | | |
| Polysorbate 20 | 5.00 | 5.00 | 5.00 |
| Glyceryl caprylate (HLB 6-7) | 0.00 | 2.00 | 0.00 |
| Propylene glycol | 1.0 | 0.00 | 0.00 |
| monoheptanoate (HLB 4-5) | | | |
| Water | 94.97 | 96.97 | 97.47 |

The formulations in Table 6 were tested for their ability to inhibit S. aureus growth and for their bacterial survivability using the Inhibition and Survivability test methodology described above, i.e. after 1:1 dilution of the solutions in the inoculum. The diluted solutions had the following concentrations of benzalkonium laurate/Monolaurin and Polysorbate with the results shown in Table 7:

TABLE 7

| | Sample # | | |
|---|---|---|---|
| Ingredients | TF-3 | TF-4 | TF-5 |
| Benzalkonium laurate/ | 0.025 wt % | 0.025 wt % | 0.025 wt % |
| Monolaurin | | | |
| Polysorbate 20 | 2.50 | 2.50 | 2.50 |
| Propylene glycol | 0.50 | 0.00 | 0.00 |
| monoheptanoate (HLB 4-5) | | | |
| Glyceryl caprylate (HLB 6-7) | 0.00 | 1.00 | 0.00 |
| Inhibition of Growth | No | No | No |
| Surviving bacterial count | 0 | 0 | TNT |

The results in Table 7 show that all three solutions formulations containing 0.025 wt % benzalkonium laurate inhibited the growth of the S. aureus bacteria. However, 2.5 wt % polysorbate (TF-5) counteracted the ability of the benzalkonium laurate to reduce survivability of the S. aureus. However, when a low HLB surfactant was incorporated is lessened the ability of polysorbate 20 to counteract the effect of benzalkonium laurate and the surviving bacterial counts were reduced by about 4 or 5 logs. containing 10 w

In a further study, in Table 8, a concentrate t % of the laurate salt of lauroyl arginine ethyl ester and monolaurin concentrate (3:1) was prepared in a similar manner to the benzalkonium laurate/ML Monolaurin (3:1) concentrate tested above in Table 5 using the following formulation:

TABLE 8

| Ingredients | wt % |
|---|---|
| Lauroyl Arginine Ethyl | 4.853 |
| Ester Hydrochloride | |
| Lauric acid | 2.213 |
| Sodium hydroxide | 0.434 |
| Monolaurin | 2.500 |
| Propylene glycol | 90.000 |
| Total | 100.000 |

The resulting product from the in situ solvent reaction of the instant invention as listed in Table 8 was a clear solution containing 7.5 wt % Lauroyl arginine ethyl ester laurate and 2.5 wt % monolaurin together with sodium chloride in propylene glycol. The resulting concentrate listed in Table 8 was used to prepare following three solutions as shown below in Table 9

TABLE 9

| | Sample # | | |
|---|---|---|---|
| Ingredients/ | TF-6 | TF-7 | TF-8 |
| LAEL/ML* 10 wt % | 1.00 wt % | 1.00 wt % | 1.60 wt % |
| concentrate | | | |
| Polysorbate 20 | 0.30 | 5.00 | 5.00 |
| Water | 90.70 | 94.00 | 93.40 |

*Lauroyl arginine ethyl ester laurate/monolaurin (3:1)

These aqueous formulations in Table 9 were tested for their ability to inhibit S. aureus growth and for their bacterial survivability using the Inhibition and Survivability test methodology described above. After 1:1 dilution of the solutions in the inoculum, the solutions had the following concentrations of LAEL/ML as listed in Table 10 as follows:

TABLE 10

| | Sample # | | |
|---|---|---|---|
| Ingredients | TF-6 | TF-7 | TS-8 |
| LAEL/ML | 0.05 wt % | 0.05 wt % | 0.08 wt % |
| Polysorbate 20 | 0.15 | 2.5 | 2.5 |
| Inhibition of growth | Yes | No | Yes |
| Surviving Bacterial count | 0 | TNC | 49 |

The results in Table 10 indicate that in this case higher levels of polysorbate (in TF-4) counteract the ability of 0.05 wt % LAEL to inhibit bacterial growth, including its ability to reduce bacterial survivability.

Overall, what the data shows is that controlled release concentrates of the invention have the ability to inhibit bacterial growth and in some cases reduce bacterial survivability. The presence of surfactants can inhibit the effectiveness of the controlled salts but not surprisingly this effect can be offset by increasing the concentration of the controlled release salt. What is unexpected is that the addition of low HLB surfactants can restore the efficacy of the controlled release salts in inhibiting bacterial growth and in reducing bacterial survivability.

### EXAMPLES

The following examples illustrate various compositions of the instant invention:

### Example 1

The following concentrate containing benzalkonium laurate was prepared according to method of the invent. In Table 11 a Benzalkonium Laurate Concentrate is described

TABLE 11

| Ingredients | Wt % | |
|---|---|---|
| Benzalkonium chloride | 11.74 | (0.207 |
| (50% aqueous solution) | | moles) |
| Lauric acid | 3.85 | (0.207 |
| | | moles) |
| Sodium hydroxide | 0.83 | (0.207 |
| | | moles) |
| Propylene Glycol | 83.30 | |
| Total | 100.00 | |

In Table 11 3.85 g of lauric acid was dissolved in 83.3 g propylene glycol and stirred with warming to accelerate dissolution. Sodium hydroxide pellets (0.83 g) were added and the solution mixed till the pellets had dissolved. Aqueous benzalkonium chloride (50 wt %) solution (11.74 g) was added with additional mixing. The final solution was clear and contained approximately 14.7 wt % dissolved benzalkonium laurate and 0.48 wt % sodium and 0.74 wt % chloride ions

### Example 1A

The following Hand or Skin Lotion in Table12 which inhibits bacterial regrowth on the hands after washing with soap was prepared using the composition of Example 1, containing benzalkonium laurate. Polysorbate 20 (0.25 g) was added to 99.04 g water and the solution was mixed. Example 1 concentrate (0.71 wt %) was added and the solution mixed. The final solution (Example 1A) in Table 12 was clear and colorless.

TABLE 12

| Ingredients | Wt % |
|---|---|
| Benzalkonium laurate | 0.71 |
| concentrate from above | |
| Polysorbate 20 | 0.25 |
| Water | 99.04 |
| Total | 100.00 |

A few drops of the lotion in Table 12 are applied directly to the hands after first washing with soap and water to retard regrowth of bacteria. Alternatively, the lotion can conveniently be applied from a hand wipe.

### Example 1B

In Table 13 the following hand wash or skin wash, which physically removes dirt and bacteria and reduces bacterial re-growth on the skin was prepared using the composition of Example 1 containing benzalkonium laurate as follows:

TABLE 13

| Ingredients | Wt % |
|---|---|
| Benzalkonium laurate | 2.00 |
| concentrate from above | |
| Cocamidopropyl amine oxide | 5.00 |
| Cocamido propyl hydroxy sultaine | 5.00 |
| Glyceryl caprylate (HLB 6-7) | 0.50 |
| Hydroxyethyl cellulose | 0.50 |
| Water | 87.00 |
| Total | 100.00 |

Using the Formulation of Example 1B as listed in Table 13, the hands are washed in warm water using approximately 1 ml of by rubbing the hands together to foam the product and remove dirt and bacteria. The hands are briefly rinsed and gently wiped dry or they may be dried in a stream of warm air. This product is particularly effective when hands are dried using stream of warm air rather than wiping dry with a hand towel.

### Example 2

In Table 14 a Cetylpyridinium Laurate Concentrate is described:

TABLE 14

| Ingredients | Wt % | |
|---|---|---|
| Cetylpyridinium cations | 4.568 | (0.015 moles) |
| Laurate anions | 2.980 | (0.015 moles) |
| Chloride anions | 0.533 | (0.015 moles) |
| Sodium cations | 0.345 | (0.015 moles) |
| Propylene glycol | 91.574 | |
| Total | 100.00 | |

The cetyl pyridinium laurate concentrate composition in Table 14 is prepared by mixing the following ingredients in Table 15 and warming, up to about 50, to help dissolve the sodium laurate.

TABLE 15

| Ingredients | Wt % | |
|---|---|---|
| Cetylpyridinium chloride | 5.11 | (0.015 moles) |
| Sodium laurate | 2.99 | (0.015 moles) |
| Propylene glycol | 91.90 | |
| Total | 100.00 | |

### Example 2A. Personal Deodorant

The cetyl pyridinium laurate concentrate as listed in Table 15 can be formulated into an aqueous personal deodorant/body as described in Table 16 as follows:

TABLE 16

| Ingredients | Wt % |
|---|---|
| Cetylpyridinium laurate concentrate (Example 2) | 1.0 |
| Water | 98.5 |
| Lipocol HCO-40 | 0.2 |
| Fragrance | 0.2 |
| Total | 100.0 |

Example 2 can also be formulated into a longer lasting anti-plaque & anti-gingivitis mouthwash as shown in the Example 2B below.

### Example 2B

In Table 17 an Anti-plaque & Gingivitis Mouthwash is described:

TABLE 17

| Ingredients | Wt % |
|---|---|
| Cetylpyridinium laurate concentrate (from Example 2) | 0.40 |
| Cetylpyridinium chloride | 0.05 |
| Sorbitol 70 wt % | 10.00 |
| Propylene glycol | 3.00 |
| Water | 84.07 |
| Poloxamer | 0.40 |
| Polysorbate 20 | 0.30 |
| Flavor oil | 0.40 |
| Di sodium phosphate | 0.10 |
| Phosphoric acid | 0.15 |
| Sodium benzoate | 0.08 |
| FD&C Blue (1 wt %) | 0.05 |
| Sucralose | 1.00 |
| Total | 100.00 |

In Table 17, the concentrate in Example 2B above provides 1:1 ratio of cetyl pyridinium ions to laurate ions. In this formulation additional free cetyl pyridinium ions were provided by the addition of soluble cetyl pyridinium chloride to provide antimicrobial cidal activity action against oral bacteria. The controlled release cetyl pyridinium laurate will serve to provide a reservoir of cetyl pyridinium laurate to replenish cetyl pyridinium ions as they are used up and to thereby inhibit re-growth of oral bacteria.

### Example 3A

Benzalkonium Myristate Concentrate Composition is described in Table 18 as follows:

TABLE 18

| Ingredients | Wt % | |
|---|---|---|
| Benzalkonium cations | 4.99 | (0.020 moles) |
| Myristate anions | 3.42 | (0.015 moles) |
| Chloride anions | 0.71 | (0.02 moles) |
| Sodium cations | 0.35 | (0.015 moles) |
| PEG 60 hydrogenated castor oil | 13.00 | |
| Water | 5.00 | |
| Propylene glycol | 72.53 | |
| Total | 100.00 | |

The benzalkonium myristate concentrate composition in Table 18 is prepared by mixing the following ingredients in Table19 and warming to up to 50 deg C. to help dissolve the sodium myristate:

TABLE 19

| Ingredients | wt % |
|---|---|
| Benzalkonium chloride (50 wt % in water) | 11.40 |
| Sodium myristate | 3.75 |
| Propylene glycol | 66.85 |
| PEG 60 hydrogenated castor oil | 13.00 |
| Water | 5.00 |

### Example 3B

Example 3 can also be formulated into a longer lasting body freshener/personal deodorant as shown in the Example 3B below. The concentrate as listed in Table19 can be formulated as listed in Table 20 as follows:

TABLE 20

| Ingredients | Wt % |
|---|---|
| Benzalkonium myristate concentrate (from Example 3 | 1.00 |
| Lipocol HCO-40 | 0.20 |
| Water | 98.60 |
| Fragrance | 0.20 |
| Total | 100.00 |

In Example 3 as listed in Table 20, the ratio of benzalkonium ions to myristate ions is 1:1.33 which provides for free benzalkonium ions to rapidly kill bacteria. When the Body Freshener in Table 20 is applied to the body, the free benzalkonium ions rapidly kill bacteria on the body. Controlled release benzalkonium myristate remains to inhibit re-growth of bacteria on the body. In this case, alcohol is not used in the above formulation since it is not needed. The excessive use of alcohol and other volatile organics in cities is considered undesirable by environmentalists due to build up of organic volatile pollutants in the air.

### Example 4

A Chlorhexidine Decanoate/Digluconate Concentrate Composition is described in Table 21 as follows:

TABLE 21

| Ingredients | Wt % | |
|---|---|---|
| Chlorhexidinium cations | 10.10 | (0.02 moles) |
| Decanoate anions | 0.86 | (0.005 moles) |
| Gluconate anions | 7.80 | (0.04 moles) |
| Potassium cations | 0.20 | (0.005 moles) |
| butylene glycol | 50.00 | |
| Water | 31.04 | |
| Total | 100.000 | |

The above composition in Table 21 is prepared according to the following formulation as listed in Table 22 below:

TABLE 22

| Ingredients | Wt % | |
|---|---|---|
| Chlorhexidinium digluconate/ | 17.94 | (0.02 moles) |
| Decanoate (20 wt %) | | |
| Potassium decanoate | 1.06 | (0.005 moles) |
| Butylene glycol | 50.00 | |
| Water | 31.00 | |
| Total | 100.00 | |

### Example 4A

In Table 23 the chlorhexidine digluconate/decanoate concentrate in Table 22 from Example 4 is used to prepare a rapid acting but extended efficacy foaming hand sanitizer as follows:

TABLE 23

| Ingredients | wt % |
|---|---|
| Chlorhexidinium digluconate/decanoate | 5.00 |
| concentrate (Example 4) | |
| Cocobetaine (35%) | 10.00 |
| Water | 84.80 |
| Fragrance | 0.20 |
| Total | 100.00 |

The hands are washed in warm water using about 1 ml of the foaming hand sanitizer listed in Table 23 by rubbing the hands together for about 1 minute. After rinsing the hands are dried with a towel or in a flow of warm air.

The following examples provide additional formulations utilizing salts of alkyl (C1 to C4) ester of N-α-(C8-C18) alkanoyl dibasic amino acid as the controlled release salt. A preferred specific cation of alkyl (C1 to C4) ester of N-α-(C8-C18) alkanoyl dibasic amino acid is the cation of lauroyl arginine ethyl ester. The rapid acting hydrochloride salt of lauroyl arginine ester is converted into a controlled release salt by dissolving it in a suitable solvent such as glycol or glycerin together with the sodium salt of a fatty acid. The resulting solution contains fatty acid salt of lauroyl arginine ethyl ester and sodium chloride. Advantages of controlled release salts of lauroyl arginine ethyl ester is that the salts are derived from natural products, i.e., lauric acid, arginine, ethyl alcohol and hence break down in the body and environment to safe metabolic bi-products of metabolism and biodegradation. The ultimate breakdown products are carbon dioxide, bicarbonate and nitrogen.

### Example 5

Table 24 describes a Lauroyl arginine ethyl ester Laurate salt Concentrate Composition as follows:

TABLE 24

| Ingredients | Wt % | |
|---|---|---|
| Lauroyl arginine ethyl ester cations | 2.98 | (0.015 moles) |
| Laurate anions | 5.78 | (0.015 moles) |
| Chloride anions | 0.53 | (0.015 moles) |
| Sodium cations | 0.35 | 0.015 moles) |
| Propylene glycol | 88.36 | |
| Lipocol HCO-40 | 2.00 | |
| Total | 100.00 | |

A solution of the lauroyl arginine ethyl ester laurate salt concentrate is prepared as described in Table 24 according to the invention methodology described herein. Accordingly, as listed in Table 25 equimolar amounts of Lauroyl ethyl ester hydrochloride and sodium laurate are dissolved in 86.68 wt % propylene glycol. 2.0 wt % Lipocol HCO-40, an emulsifier is added and the solution mixed to form a clear liquid.

TABLE 25

| Ingredients | wt % | |
|---|---|---|
| Lauroyl arginine ethyl ester hydrochloride | 6.33 | (0.015 moles) |
| Sodium laurate | 3.30 | (0.015 moles) |
| Propylene glycol | 88.37 | |
| Lipocol HCO-40 | 2.00 | |
| Total | 100.00 | |

### Example 5A

To prepare a deodorant spray formulation from the concentrate in Table 25 containing the Laurate salt of Lauroyl arginine ethyl ester, 0.75 wt % of the concentrate composition is diluted in 99 wt % ethanol and 0.2 lavender fragrance and 0.05 wt % rosemary oil is added. Example 5A is a non-aqueous body spray deodorant as listed in Table 26 made from the above composition as follows:

TABLE 26

| Ingredients | |
|---|---|
| Lauroyl arginine ethyl ester laurate Concentrate | 0.75 wt % |
| Ethanol | 99.99 |
| Lavender fragrance | 0.20 |
| Rosemary oil | 0.05 |
| Total | 100.00 |

After application to the underarm of the formulation as listed in Table 26, the strong bactericidal action of the alcohol produces immediate kill of the bacteria present, after which the alcohol evaporates. The controlled release laurate salt of lauroyl arginine ethyl ester salt, which is left on the skin after alcohol evaporation, partially dissolves in the moisture on the skin and the lauroyl arginine ethyl ester cations in solution prevent bacterial re-growth. Additional laurate salt of lauroyl arginine ethyl ester replenishes the dissolved lauroyl arginine ethyl ester cations as they are used up or depleted to provide an extended period underarm deodorization

Example 5B is a Deodorant Stick formulation as listed in Table 27 made from the composition as listed in Table 25 as follows:

TABLE 27

| Ingredients | |
|---|---|
| Lauroyl arginine ethyl ester laurate concentrate | 1.50 wt % |
| Polypropylene glycol (3) Myristyl ether | 70.00 |
| Propanediol | 16.00 |
| Sodium stearate | 9.30 |
| Water | 3.00 |
| Fragrance oil | 0.20 |
| Total | 100.00 |

### Example 5C

The following composition as listed in Table 28 is prepared as a mild hand wash which physically removes dirt and bacteria and prevents bacterial regrowth. It uses the concentrate as listed in Table 25 as follows:

TABLE 28

| Ingredients | wt % |
|---|---|
| Lauroyl arginine ethyl ester laurate concentrate | 2.50 |
| Cocamido propyl hydroxysultaine | 10.00 |
| Glyceryl caprylate (HLB 6-7) | 0.50 |
| Sorbitan Stearate | 1.00 |
| Water | 85.70 |
| Fragrance | 0.30 |
| Total | 100.00 |

The hands are wetted with warm water and approximately 1 ml of Example 5C solution as listed in Table 28 is applied to the wet hands which are then are rubbed together to foam the concentrate and remove dirt and bacteria. The hands are briefly rinsed in warm water and patted dry or dried in a stream of warn air.

Terms used in the claims are intended to be interpreted, first, as would be understood by one of skill in (w/w) % is also known as % (w/w), or wt. %, or wt % or wt %, or % by weight but all refer to the weight of an added ingredient as compared to the weight of the whole composition. The term cidal is the same as biocidal and is intended to indicate that bacteria, yeasts, molds, fungi are killed. Sometimes this function is referred to as antimicrobial activity. The abbreviation LAE is sometimes used in this specification to refer to Lauroyl arginine ethyl ester, or lauric arginate, ethyl lauroyl arginate, L-Arginine ethyl ester, or Na-lauroyl-L-arginine. In this specification the terms 4 part mixture or 4 part composition or four-part ionic composition, four-part, or four-part mixture all refer to a composition comprising: (i) one or more antimicrobial cation; (ii) one more anion of an organic acid; (iii) an ammonium or alkali metal cation; and (iv) a monovalent anion; and if not thus interpretable, in accordance with a scientific dictionary related to such field; and then if not thus interpretable, a general dictionary may be used

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A controlled release antimicrobial salt composition prepared by a process comprising
(1) adding from about 0.02 (w/w) % to about 20 (w/w) % of a four-part ion mixture comprising:
(i) one or more antimicrobial cation;
(ii) one or more anions of an organic acid;
(iii) an ammonium or alkali metal cation; and
(iv) an anion, wherein each of (i) and (ii) are in a molar-ratio of to each other between approximately 1:1 and 6:1, to
(2) from about 0.2 (w/w) % to about 99.9 (w/w) % of a solvent selected from the group consisting of: propylene glycol, glycerin, 1,3 propanediol, butylene diol, pentylene glycol, hexylene glycol, and octanediol for dissolving and dispersing the ions of the four-part mixture, heating and mixing until uniform, so that a composition concentrate is formed that comprises dissociated ions; and
(3) adding the composition concentrate to from about 0.1 (w/w) % to about 99.5 (w/w) % water or deionized water,
wherein a controlled release antimicrobial salt composition is formed by the addition of water to the composition concentrate, the controlled release antimicrobial salt, formed between (i) and (ii), having a solubility in water at 20° C. of greater than about 0.001 (w/w) %, but less than about 1 (w/w) %.

2. The controlled release antimicrobial salt composition of claim 1, the composition further comprising one or more of:
optionally, (4) from about 0.05 (w/w) % to about 10 (w/w) % emulsifier; and
optionally, (5) from about 0.1 (w/w) % to 99.9 (w/w) % of a second suitable solvent from solvent (2);
optionally, (6) from about 0.05 (w/w) % to about 0.5 (w/w) % fragrance or flavor oil; and
optionally, (7) from about 0.005 (w/w) % to about 0.2 (w/w) % of a colorant.

3. The controlled release antimicrobial salt composition of claim 1, wherein the salt formed from the (i) the antimicrobial cations and (ii) organic acid anions has a solubility in water at 20° C. of greater than about 0.003 (w/w) %, but less than about 0.5 (w/w) %.

4. The composition of claim 1, wherein the (ii) organic acid ion is selected from the group consisting of: acetate, propionate, butyrate, caproate, caprylate, decanoate, undecylenate, laurate, myristate, palmitate, stearate, oleate, linoleate, lactate, salicylate, glycolate, tartrate, malonate, malate, succinate, citrate, gluconate, glycerate and glyoxylate, ascorbate, retinoate, sorbate, and dehydroacetate.

5. The controlled release antimicrobial salt composition of claim 1, wherein the (iii) alkali metal cation is selected from the group consisting of sodium and potassium.

6. The controlled release antimicrobial salt composition of claim 1, wherein the (iv) anion is selected from the group consisting of: chloride, bromide, acetate, sulphate, phosphate, nitrate, nitrite, and gluconate.

7. (canceled)

8. The controlled release antimicrobial salt composition of claim 2, wherein the emulsifier (4) is a nonionic or amphoteric surfactant and has an HLB of greater than or equal to about 10.

9. The controlled release antimicrobial salt composition of claim 8, wherein the nonionic surfactant is selected from the group consisting of: an ethoxylated alcohol, PEG-40 hydrogenated castor oil, PEG-60 hydrogenated castor oil, polysorbate 20, polysorbate 40, polysorbate 60 and polysorbate 80, an alkyl polyglucoside, and mono and di saccharide esters of a fatty acid with 8 to 18 carbons.

10. The composition of claim 9, wherein the mono and di saccharides are selected from the group comprising fructose, glucose, galactose, sucrose, lactose, and maltose.

11. The controlled release antimicrobial salt composition of claim 8, wherein the amphoteric surfactant is an alkali metal or ammonium salt or a compound selected from the group consisting of: an alkyl amphoacetate, an alkyl amphodiacetate, an alkyl amphopropionate, an alkyl amphodipropionate, a betaine derivative, an alkyl betaine, an alkyl amidobetaine, an imadazoline derivative, a sulfobetaine derivative, a sultaine derivative, a hydroxysultaine derivative, an alkyl iminoacetate, and an iminodialkanoate.

12. The controlled release antimicrobial salt composition of claim 1, wherein the antimicrobial cation is selected from the group consisting of: N^{α}-lauroyl-L-arginine ethyl ester cation, cetylpyridinium cation, benzethonium cation, a (C8-C18) alkyl dimethyl benzyl ammonium (benzalkonium) cation, a dialkyl (C8-C18) methyl benzyl ammonium cation, a dialkyl (C8-C18) dimethyl ammonium cation, and chlorhexidinium cation.

13. The controlled release antimicrobial salt composition of claim 1, prepared by a process consisting essentially of:
(1) adding from about 0.02 (w/w) % to about 20 (w/w) % of a four-part ion mixture comprising:
(i) one or more antimicrobial cations;
(ii) one or more anions of an organic acid;
(iii) an ammonium or alkali metal cation; and
(iv) an anion, wherein each of (i) and (ii) are in a molar-ratio of to each other between approximately 1:1 and 6:1;
(2) to from about 0.2 (w/w) % to about 99.9 (w/w) % of a solvent selected from the group consisting of: propylene glycol, glycerin, 1,3 propanediol, butylene diol, pentylene glycol, hexylene glycol, and octanediol for dissolving and dispersing the ions of the four-part mixture, so that a composition concentrate is formed that comprises dissociated ions; and
(3) adding the composition concentrate to from about 0.1 (w/w) % to about 99.5% (w/w) % water or deionized water,
wherein a controlled release antimicrobial salt composition is formed by the addition of water to the composition concentrate, the controlled-release antimicrobial salt formed between (i) and (ii), having a solubility in water at 20° C. of greater than about 0.001 (w/w) %, but less than about 1 (w/w) %.

14. A method of forming a controlled release antimicrobial salt in situ at a site that has moisture present comprising:
(A) adding (1) from about 0.02 (w/w) % to about 20 (w/w) % of a four-part ion mixture comprising:
(i) one or more antimicrobial cations;
(ii) one or more anions of an organic acid;
(iii) an ammonium or alkali metal cation; and
(iv) an anion, wherein each of (i) and (ii) are in a molar-ratio of to each other between approximately 1:1 and 6:1,
to (2) from about 0.2 (w/w) % to about 99.9 (w/w) % of a solvent selected from the group consisting of: propylene glycol, glycerin, 1,3 propanediol, butylene diol, pentylene glycol, hexylene glycol, and octanediol for dissolving and dispersing the ions of the four-part mixture, so that a composition concentrate is formed that comprises dissociated ions;
(B) adding to the composition concentrate, optionally, one or more of:
optionally, (3) from about 0.05 (w/w) % to about 10 (w/w) % emulsifier; and
optionally, (4) from about 0.1 (w/w) % to 99.9 (w/w) % of a second suitable solvent distinct from solvent (2);
optionally, (5) from about 0.05 (w/w) % to about 0.5 (w/w) % fragrance or flavor oil; and
(C) adding the composition concentrate to from about 0.1 (w/w) % to about 99.5 (w/w) % of an anhydrous solvent to form a diluted composition, and
(4) applying the diluted composition to a site that has moisture present, wherein, the moisture of the site causes the dissociated ions to form a controlled release antimicrobial salt between (i) and (ii), at the site of application.

15. (canceled)

16. A process for producing a controlled release antimicrobial salt comprising:
(A) dissolving, heating and mixing until uniform:
(1) from about 0,02 (w/w) % to about 20 (w/w) % of (1) a four-part ion mixture comprising:
(i) one or more antimicrobial cations;
(ii) one or more anions of an organic acid;
(iii) an ammonium or alkali metal cation; and
(iv) an anion, wherein each of (i) and (ii) are in a molar-ratio of to each other between approximately 1:1 and 6:1; and
(2) from about 0.2 (w/w) % to about 99.9 (w/w) % of a solvent selected from the group consisting of: propylene glycol, glycerin, 1,3 propanediol, butylene diol, pentylene glycol, hexylene glycol, and octanediol for dissolving and dispersing the ions of the four-part mixture, so that a composition concentrate is formed that comprises dissociated ions; and
(B) adding the composition concentrate to (3) from about 0.1 (w/w) % to about 99.5 (w/w) % water or deionized water,
wherein a controlled release antimicrobial salt composition is formed by the addition of water to the composition concentrate, the controlled-release antimicrobial salt, formed between (i) and (ii), having a solubility in water at 20° C. of greater than about 0.001 (w/w) %, but less than about 1 (w/w) %.

17. The process of claim 16, wherein,
the (i) cationic antimicrobial salt selected from the group consisting essentially of: N^{α}-lauroyl-L-arginine ethyl ester cation, cetylpyridinium cation, benzethonium cation, a (C₈-C₁₈) alkyl dimethyl benzyl ammonium (benzalkonium) cation, a dialkyl (C₈-C₁₈) methyl benzyl ammonium cation, a dialkyl (C₈-C₁₈) dimethyl ammonium cation, and chlorhexidinium cation.

18. The process of claim 16, the process further comprising one or more of:
optionally, (4) from about 0.05 (w/w) % to about 10 (w/w) % emulsifier; and
optionally, (5) from about 0.1 (w/w) % to 99.9 (w/w) % of a second suitable solvent distinct from solvent (2);
optionally, (6) from about 0.05 (w/w) % to about 0.5 (w/w) % fragrance, scent or flavor oil;
optionally (7) from about 0.005 (w/w) % to about 0.2 (w/w) % of a colorant; and
optionally (8) preservatives, emollients, cleaning agents are added to the composition.

19. The process of claim 15, further comprising:
(C) mixing until uniform from about 0.1% (w/w) to about 10% (w/w) of the controlled release antimicrobial salt four-part mixture with one of the following:
(a) from about 75% (w/w) to about 99.9% (w/w) deionized water;
(b) from about 75% (w/w) to about 99% (w/w) of additional suitable solvent; or
(c) from about 75% (w/w) to about 99% (w/w) of a second suitable solvent in which the ingredients of the composition are soluble,
wherein, a diluted a controlled release antimicrobial salt composition is formed.

20. (canceled)
